(19) United States
(12) Patent Application Publication
(10) Pub. No.: US 2004/0195304 A1
(43) Pub. Date: Oct. 7, 2004

(54) Locking mailbox

(76) Inventors: Paul D. Kujawa, Apple Valley, MN (US); Kevin R. Caple, Apple Valley, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/404,613

(22) Filed: Apr. 1, 2003

(51) Int. Cl. B65G 11/04

(52) U.S. Cl. 232/45

(57) ABSTRACT

A mailbox comprises a housing and a hinged door, a spring loaded locking mechanism is attached to the housing and the door, a delivered mail detection mechanism 22, and an outgoing mail indicator means operably cooperate with the locking mechanism to enable or disable the locking mechanism under appropriate conditions as described herein. The delivered mail detection mechanism includes an external mail present indicator.

### BACKGROUND OF THE INVENTION

This invention relates to mailboxes, more particularly the invention relates to mailboxes with locking mechanisms and mail-present indicators.

Mailboxes for individual postal customers are an integral and necessary component in the operation of the US Postal Service. It is desirable that incoming mail be secured in the mailbox to prevent theft or observation of the incoming mail which may contain valuable documents, checks, credit cards, personal letters or other items of value to the mailbox owner that would cause loss or inconvenience if observed or stolen by an unauthorized person. If the person removing or inspecting the mail is not authorized, the authorized user of the mailbox may suffer an injury of either lost property or lost privacy. A lock on the access door can restrict access to the mailbox to the person with the key to the lock, thus providing an improved level of security by limiting authorized access to the mailbox only those people who properly have a key to open the mailbox door. In certain settings, such as apartment buildings or offices where there is a single delivery point for numerous postal customers, locked mailboxes with the mail carrier having a key for delivery of mail is a practical solution.

The typical rural or suburban roadside mailbox has a front access door hinged at the bottom and side indicating flag used to signal to a motorized mail carrier that outgoing mail is available for pickup. In the conventional mailbox, delivered incoming mail can be easily removed or inspected by anyone driving or walking by and opening the front access door. Simply installing locks and providing the mail carriers with keys or other means to access many different locked mailboxes to deliver incoming mail in a rural or suburban setting would inefficient, potentially unsafe to the mail carrier, and otherwise problematic.

Therefore, the access door needs to remain unlocked before the mail carrier arrives so the mail carrier can open the access door to either remove outgoing mail from inside the mailbox or deposit incoming mail inside the mailbox, or both. After the mail carrier has deposited incoming mail and closes the access door, the access door would desirably lock shut to prevent unauthorized access. The drawback to such an arrangement is that a self-actuating lock would lock whenever anyone shut the mailbox door, including the postal customer, when they are depositing mail for pickup.

A solution to avoiding unauthorized access to incoming mail include having the access door remain unlocked but also having the incoming mail fall far enough away from the access door so that the incoming mail cannot be retrieved by reaching into the mailbox through the access door. In this case, the mail is typically retrieved by an authorized user by unlocking a second access door close to where the mail has fallen. This solution requires a limited access door, restricting the size and quantity of mail that can be easily delivered. Also, the size of the mailbox may be cumbersome.

Another solution to avoiding unauthorized access to incoming mail is to have the door be initially unlocked and then have it automatically lock shut when the door is open and then closed. The door is shut typically by the mail carrier, who opens the mailbox, removes outgoing mail or inserts incoming mail, or both, then closes the door. The door then becomes locked shut. This provides the desired security if the mailbox door is not opened and then shut before the mail carrier arrives to deliver mail. However, if the door must be opened to add additional outgoing mail or otherwise check the status of the outgoing mail, the door will lock shut when it is closed. The outgoing mail is then locked in the mailbox and unavailable for pickup by the mail carrier, and incoming mail cannot be delivered because the door is locked shut.

Arrival of incoming mail is typically not signaled to the authorized user of the mailbox, but can only sometimes be inferred from the position of the outgoing mail flag. If the outgoing mail flag was raised, signaling to the mail carrier that outgoing mail is available for pick-up, but the flag is later observed to be down, it can be inferred that the mail carrier has taken the outgoing mail because mail carriers typically reset the outgoing mail flag to the lowered position after they pick up the outgoing mail. It cannot be inferred in this scheme whether the mail carrier has delivered incoming mail, only the status of the outgoing mail can be inferred.

It would be desirable to have a mailbox that would have a latching mechanism that would be enabled only when delivered mail is inserted into the mail box and/or when mail for pickup in the mailbox is removed by the mail carrier.

### SUMMARY OF THE INVENTION

According to a preferred embodiment of the invention, a mailbox comprises an enclosure with a front opening through which mail can pass for receiving or removing incoming or outgoing mail with respect to the enclosure. The opening of the enclosure is closeable with a hinged door that fully covers the opening. The door is provided with a locking means such that when the door is closed, a spring loaded latch configured as a detent, may be automatically engaged with a catch on the enclosure such that the door remains closed and locked. The mailbox can have an outgoing mail signaling device, or flag, that is used to alert the mail carrier that outgoing mail is available for pickup. The mailbox may also have a second signaling device or flag that indicates the presence or absence of mail inside the mailbox. The mailbox may also have an incoming mail flap that stands in an upright position. In normal operation this upright position of the incoming mail flap controls a signaling device indicating that there is no mail currently in the mailbox. If incoming or outgoing mail is placed in the mailbox, the incoming mail flap must be pushed down and out of the way, into a substantially horizontal position, making room for the mail to be placed in the mailbox.

The access door remains unlocked before the mail carrier arrives so the mail carrier can open the access door to either remove outgoing mail from inside the mailbox or deposit incoming mail inside the mailbox, or both. After the mail carrier has deposited incoming mail and closes the access door, the access door locks shut to prevent unauthorized access.

It is an object of the invention to provide a mailbox that allows for outgoing mail pick-up and incoming mail drop-off, with easy access by the mail carrier for the outgoing mail while safely storing delivered incoming mail behind a locked access door, and allowing retrieval of the delivered mail only by an authorized person with a key that unlocks the access door. Additionally, the invention, in certain embodiments, can provide an external indication of whether incoming mail has been delivered.

### BRIEF DESCRIPTION OF THE DRAWINGS

FIG. 1 is an elevational view of a mailbox according to an embodiment of the invention.

FIG. 2 is a cutaway perspective view of a mailbox according to an embodiment of the invention.

FIG. 3 is a cross sectional view of a portion of the mailbox of FIG. 2 taken along the line 2-2.

FIG. 4 is a cross sectional view of a portion of the mailbox of FIG. 2 taken along the line 4-4.

FIG. 5 is a front elevational view looking into the front of the mailbox of FIG. 2.

FIG. 6 is a plan cross sectional view taken at approximately line 6-6 of FIG. 4.

### DETAILED DESCRIPTION OF PREFERRED EMBODIMENTS

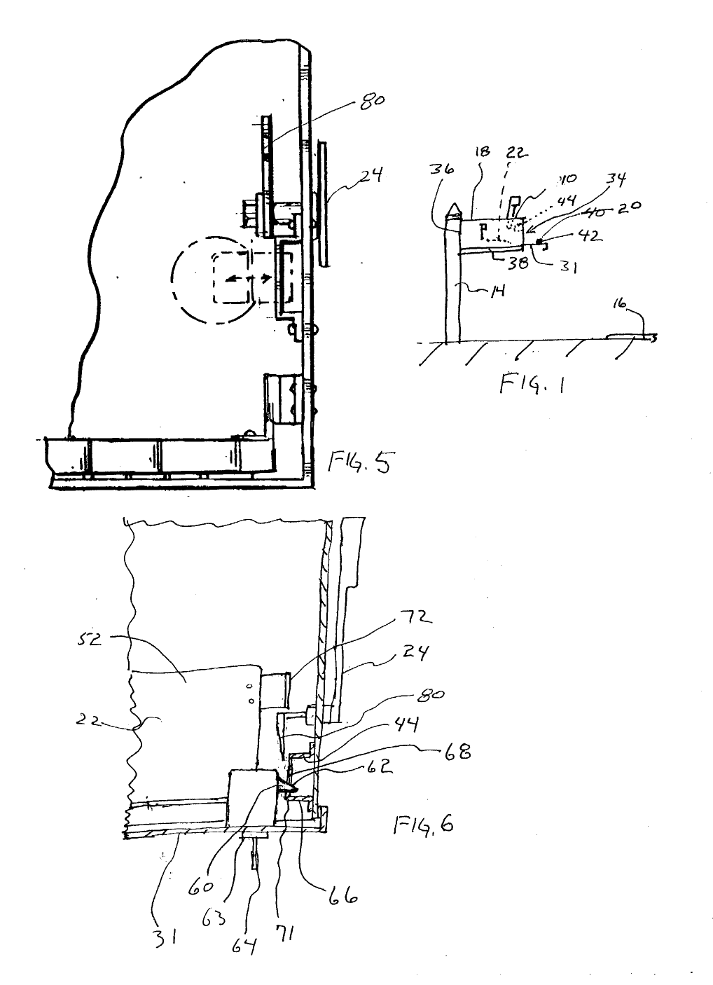

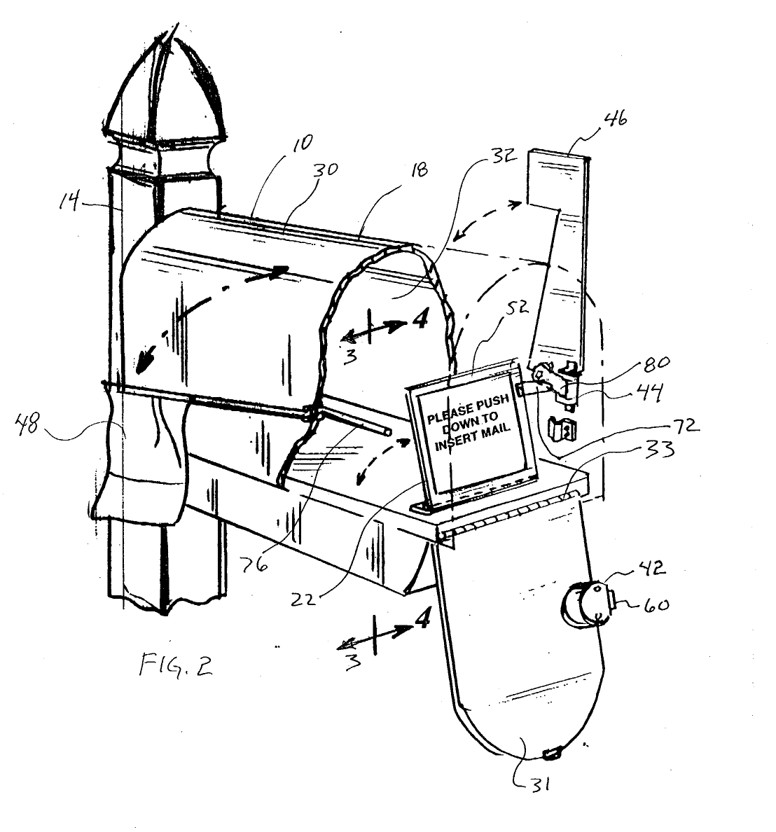

Referring to FIGS. 1 and 2, a preferred embodiment of the invention is illustrated. The invention includes a mailbox 10, mounted on a standard 14 adjacent to a roadway 16. The mailbox generally comprises a housing 18, a spring loaded latching means or locking mechanism 20, a delivered mail detection mechanism 22, and an outgoing mail indicator means configured as a flag mechanism 24. The delivered mail detection mechanism and the flag mechanism cooperate with the locking mechanism to enable or disable the locking mechanism under appropriate conditions as described herein.

The housing 18 comprises an enclosure portion 30 and a door 31 attached with a hinge 33. The enclosure portion has an open interior 32, an open end 34, a closed end 36, and a lower base 38. The latching or locking mechanism 20, has a first portion 42 and a cooperating second portion 44. Two external mail indicators, configured as a primary flag 46, part of the flag mechanism 24 and a secondary flag 48, part of the delivered mail detection mechanism 22, extend from the enclosure portion of the housing. The primary flag may be configured as conventional mailbox flag that indicates mail is ready for pickup by the mail carrier. The secondary flag indicates to the postal customer that mail has been delivered. An internal actuation member configured as a flap 52 is mounted in the interior of the housing and is linked to the secondary flag. Generally the housing may be formed by conventional means of sheet metal or other rigid materials.

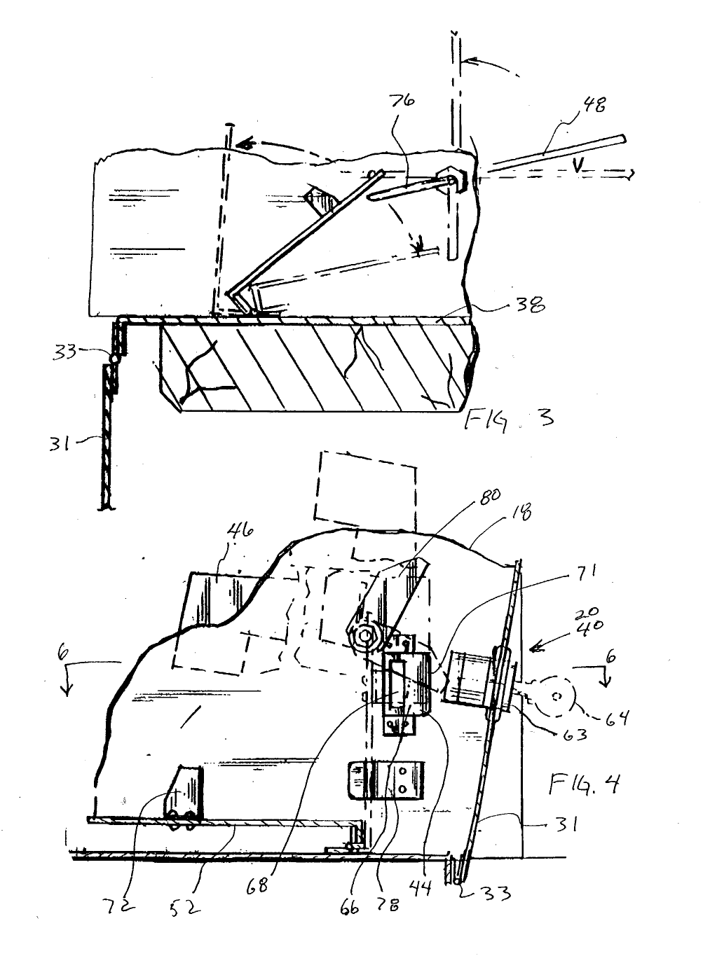

Referring to FIGS. 2, 3, 4, 5 and 6, details of a preferred embodiment of the invention are illustrated. The first portion 42 of the locking mechanism 40 is preferably attached to the door and has a retractable detent 60 or plunger that is spring loaded and that has an angled cam surface 62. A key receiving portion 63 and a key 64 manually retract the detent. The second portion 44 is configured as a catch 66 suitably attached, such as by rivets or welding to the enclosure portion, has a detent receiving portion configured as an aperture 68. When the door is shut and the detent engages with the catch at the engagement surface 71 the detent retracts until the door is sufficiently shut such that the detent reaches the aperture 68 where it then extends and is thus automatically latched when the door is shut, presuming that the aperture is unobstructed. Unlatching requires use of the key to manually retract the detent or plunger. The locking mechanism 40, may be disabled by obstructing the aperture such that the detent can not extend into same.

The delivered mail detection mechanism 22 has the flap 52 pivotally mounted to the base of the enclosure portion and has an obstructing portion or member 72 attached thereto. The flap has an upright position as shown in FIG. 2 and a retracted or lowered position as shown in FIG. 4. In the upright position, the flap effectively precludes entry of mail into the open interior and the obstructing member interferes with the engagement of the first portion of the locking mechanism with the second portion by covering or blocking the aperture or catch of the second portion of the locking mechanism. The flap preferably includes indicia instructing the postal carrier to depress or retract the flap for insertion of mail. Such depression removes the obstructing member from the covering or blocking position of the aperture or catch. When covered or blocked by the obstructing member 72, the locking member is disabled.

The delivered mail detection mechanism also is linked to the secondary flag 48 by the flap 52 engaging a lever arm 76, depressing the lever arm to rotate the secondary flag 48 upwardly, raising the secondary flag as illustrated in FIG. 3. A spring friction interference member 78 attached to the housing may be utilized to secure the flap in the upright position.

The primary flag mechanism 24 has the flag 46 pivotally mounted to the enclosure portion and fixed to an additional second obstructing member 80. As the flag is rotated from the lowered position, shown in FIGS. 4 and 7, to the raised, “mail present” upright position of FIG. 1, the obstructing member 80 rotates into an obstructing position interfering with the engagement of the first portion of the locking mechanism with the second portion by covering or blocking the aperture or catch of the second portion. This similarly disables the locking mechanism.

The delivered mail detection mechanism 22 and the primary flag mechanism 24 each operate independently of one another and thus each could be present in a mailbox without the other and such is still considered within the scope of the invention herein. Moreover, in certain embodiments, the secondary flag is not a required part of the delivered mail detection mechanism in that the detection mechanism can function to enable the locking mechanism without providing an external “delivered mail present” signal.

Further description of the operation and functioning of the device follows. The present invention provides for the obstructing or a blocking member be interposed between the spring loaded latching means on the door and the catch on the enclosure portion, which prevents the spring loaded latching means from engaging the catch, so that the access door can be closed but will remain unlocked until the interposed obstructing member is removed from between the spring loaded latching means and the catch. These movable obstructing members 72, 80 are preferrably in the form of a metal blade portion, connected to the outgoing mail indicator means 24 or of another metal blade portion connected to the incoming mail flap 52, or both. The blade configuration facilitates that either blade portion or both may be in an obstructing position and either one may be moved in and out of the obstructing position with the other one in the obstructing position.

When the outgoing mail signaling device, the primary flag 46, is raised to alert the mail carrier of the presence of outgoing mail, the metal blade portion connected to the outgoing mail signaling device is interposed in the latching mechanism 20 keeping the door 31 from locking in the closed position. In this way the mail carrier can open the door and remove the outgoing mail. The mail carrier will normally lower the outgoing mail flag 46, causing the metal blade portion to be removed from its position interposed between the spring loaded latching means and the catch. The door will then lock when it is placed in the closed position. If the access door 31 is already closed and the metal blade portion is removed from the interposed position, the latching mechanism 20 will now engage the catch and the door will become locked.

When the flap 52 is raised to indicate the absence of mail, a second metal blade portion is interposed between the first portion of the latching mechanism and the catch, keeping the door from becoming locked if it is placed in the closed position. Upon the receiving mail into the enclosure, the flap is lowered and the metal blade portion attached to the flap is removed from its position interposed between the first portion of the latching mechanism and the catch, and the door will lock when it is closed. This mode of operation is useful when there is no outgoing mail and the outgoing mail indicator is lowered, which normally would allow the door to lock. However the mail carrier would not be able to open the door to deliver incoming mail. In particular embodiments of the present invention, the flap is manually raised by the authorized user, the mailbox door is closed and the metal blade portion of the flap prevents the mailbox from locking. The mail carrier can still open the door and insert mail. Under normal operation, inserting mail then causes the flap to be lowered. When the mail carrier then closes the door, the door locks and the incoming mail is secured inside the locked mailbox.

This second signaling device, the secondary flag, becomes important because if the security of the incoming mail is of concern to the authorized user, security of outgoing mail is likely a similar issue. In this case the authorized user may never leave outgoing mail in the mailbox because the access door must necessarily remain unlocked, and thus available to anyone besides the mail carrier. In this situation there is rarely outgoing mail and there can be no indication of whether the mail carrier has yet made a delivery of incoming mail to be retrieved. If there has been a delivery of incoming mail, it is important that the incoming mail be removed because the access door is locked and the mail carrier may make no further deliveries until the access door is unlocked. By using the position of the flap to activate a second signaling device, the presence of incoming mail is correctly indicated. Before the mail carrier arrived the flap would be set in a vertical position, a position it can assume if there is no mail in the mailbox. Also since there is no outgoing mail, the outgoing mail indicator is in a less visible position, for example a down, or horizontal, position. If the mail carrier delivers incoming mail, the door can be opened, the flap pushed down and the mail inserted inside the mailbox. When the flap is pushed down, the second indicator flag is moved to a more visible position, for example, a raised upright position. The door is closed, and because the metal portion from the flap is no longer interposed between the first portion of the latching mechanism and catch, the access door becomes locked shut.

In all cases, once the door is closed and locked, the access door must be opened by use of a key and the flap must be raised if there is no outgoing mail, or the outgoing mail can be deposited and the outgoing mail indicator must be raised, thus keeping the access door from locking upon subsequent closing. In this manner the mail carrier may open the access door again upon the next arrival to remove any outgoing mail or deliver incoming mail, or both.

The only way to open the locked access door in preferred embodiments is by operation of the unlocking mechanism, typically by use of a key. Movement of the outgoing mail indicator or the flap will not unlock a closed and locked access door.

Additional embodiments of the current invention may include a mechanism for maintaining the access door in an intermediate closed position, such that the door remains closed but does not lock. The position of the interposed metal portion or portions does not affect the operation of this intermediate closed position. When the access door is in this position the door can be opened and subsequently returned to this intermediate position without engaging the latching mechanism. In one embodiment, the intermediate position can be maintained by providing a friction interference with a detent between the access door and the enclosure, such that the interference detent indicates when the door is in the intermediate closed but unlocked position. If the access door is further closed beyond the intermediate position, the latching mechanism on the access door can engage the catch on the enclosure. The interposed metal portions from the flap or the outgoing mail signaling device can control whether the latching mechanism engages the catch and the access door becomes closed and locked.

Although the description above contains many specificities, these should not be construed as limiting the scope of the invention but as merely providing illustrations of some of the presently preferred embodiments of the invention. Thus, the scope of the invention should be determined by the appended claims and their legal equivalents, rather than by the examples given.

What is claimed is:

1. A mailbox for placement adjacent a roadway,
a mailbox housing having an interior and an open end for insertion and removal of mail;
an access door movably mounted to said housing for movement between a first vertical closed position and a second lowered open door position;
a locking mechanism for locking the door into the first vertical closed position, the locking mechanism having a first portion with a detent, and a cooperating second portion having an detent receiving portion, the first portion attached to one of the access door and the housing, the second portion attached to the other of the housing and door, whereby the detent is retractable and extendable to engage the detent receiving portion when the door is moved from the lowered open door position to the closed position; and
a flag mechanism pivotally attached to the housing, the flag mechanism comprising a flag exterior of the housing and an obstruction portion in the interior of the housing, the flag moveable from an upright position to a lowered position, the obstruction portion coupled to the flag whereby when the flag is in the upright position, the obstruction portion obstructs the detent from engaging the detent engaging portion.

2. The mailbox according to claim 1, wherein the detent has a cam surface for engaging and retracting the detent as the door is moved to the closed position.

3. The mailbox according to claim 1, wherein the detent portion of the locking mechanism comprises a key receiving portion that is manually operable for retracting the detent.

4. The mailbox according to claim 1 further comprising a flap mechanism pivotally attached to the housing in the interior of the housing, the flap mechanism comprising a flap and an obstruction portion, the flap moveable from an upright position blocking introduction of mail into the interior of the mail box to a lowered position allowing placement of mail, the obstruction portion coupled to the flap whereby when the flap is in the upright position, the obstruction portion obstructs the detent from engaging the detent engaging portion

5. The mailbox according to claim 4, wherein the flap mechanism further comprises a secondary mail flag having first position and a second position, the secondary mail flag coupled to the flap whereby when the secondary mail flag is moveable between the first position and the second position when the flap moves from the upright position to the lowered position.

6. The mailbox according to claim 4, wherein the first portion of the locking mechanism is attached to the door.

7. A mailbox for placement adjacent a roadway, the mailbox comprising:
a mailbox housing having an interior and an open end for insertion and removal of mail;
an access door movably mounted to said housing for movement between a first vertical closed position and a second lowered open door position;
a locking mechanism for locking the door into the first vertical closed position, the locking mechanism having a first portion with a detent, and a cooperating second portion having an detent receiving portion, the first portion attached to one of the access door and the housing, the second portion attached to the other of the housing and door, whereby the detent is retractable and extendable to engage the detent receiving portion when the door is moved from the lowered open door position to the closed position; and
a flap mechanism pivotally attached to the housing in the interior of the housing, the flap mechanism comprising a flap and an obstruction portion, the flap moveable from an upright position blocking introduction of mail into the interior of the mail box to a lowered position allowing placement of mail, the obstruction portion coupled to the flap whereby when the flap is in the upright position, the obstruction portion obstructs the detent from engaging the detent engaging portion.

8. The mailbox according to claim 7, wherein the detent portion of the locking mechanism comprises a key receiving portion that is manually operable for retracting the detent.

9. The mailbox according to claim 7, wherein the flap mechanism further comprises a secondary mail flag having first position and a second position, the secondary mail flag coupled to the flap whereby when the secondary mail flag is moveable between the first position and the second position when the flap moves from the upright position to the lowered position.

10. The mailbox according to claim 7, further comprising a flag mechanism pivotally attached to the housing, the flag mechanism comprising a flag exterior of the housing and an obstruction portion in the interior of the housing, the flag moveable from an upright position to a lowered position, the obstruction portion coupled to the flag whereby when the flag is in the upright position, the obstruction portion obstructs the detent from engaging the detent engaging portion.

11. A mailbox for placement adjacent a roadway,
a mailbox housing having an interior and an open end for insertion and removal of mail;
an access door movably mounted to said housing for movement between a first vertical closed position and a second lowered open door position;
a primary mail indicating flag pivotally attached to the housing;
a flap mechanism pivotally attached to the housing in the interior of the housing, the flap mechanism comprising a flap moveable from an upright position blocking introduction of mail into the interior of the mail box to a lowered position allowing placement of mail, the flap mechanism further comprising a secondary mail flag having first position and a second position, the secondary mail flag coupled to the flap whereby the secondary mail flag moves between the first position and the second position when the flap moves from the upright position to the lowered position.

12. The mailbox according to claim 11, further comprising a locking mechanism for locking the door into the first vertical closed position, the locking mechanism having a first portion with a detent, and a cooperating second portion having an detent receiving portion, the first portion attached to one of the access door and the housing, the second portion attached to the other of the housing and door, whereby the detent is retractable and extendable to engage the detent receiving portion when the door is moved from the lowered open door position to the closed position; and

13. The mailbox according to claim 12, wherein the flap mechanism further comprises an obstruction portion coupled to the flap whereby when the flap is in the upright position, the obstruction portion is positioned in an obstruction position blocking the engagement of the detent with the detent receiving portion when the door is moved from the lowered open door position to the closed position.

14. The mailbox according to claim 11, further comprising a flag mechanism pivotally attached to the housing, the flag mechanism comprising a flag exterior of the housing and an obstruction portion in the interior of the housing, the flag moveable from an upright position to a lowered position, the obstruction portion coupled to the flag whereby when the flag is in the upright position, the obstruction portion obstructs the detent from engaging the detent engaging portion.

15. A mailbox comprising:
a housing comprising an enclosure portion and a door hinged thereto;
a spring loaded latching mechanism comprising a first portion on the door and a cooperating second portion with a catch on the enclosure portion;
an obstructing portion attached to the housing and moveable into and out of an obstructing position with the latching mechanism thereby disabling and enabling the locking mechanism.

16. The mailbox of claim 15 wherein when the obstructing portion moves to the obstructing position, the obstructing portion covers the catch portion.

17. The mailbox of claim 15 further comprising a mail delivered detection mechanism comprising a actuation member that has an upright position that blocks the introduction of mail into the mailbox and a retracted position that allows introduction of mail, the actuation member coupled to the obstructing member such that when the actuation member is in the upright position the obstructing member is in the obstructing position disabling the latching mechanism.

18. The mailbox of claim 15 further comprising a flag mechanism comprising an external flag for indicating the presence of outgoing mail to be picked up, the flag pivotally mounted to the enclosure portion and moveable between an upright position and a lowered position, the flag connecting to the obstructing portion whereby when the flag is in an upright position the obstructing portion is in an obstructing position disabling the latching mechanism.

19. The mailbox according to claim 15 further comprising an incoming mail received indicator mechanism pivotally attached to the housing in the interior of the housing, the incoming mail received indicator mechanism comprising a flap moveable from an upright position blocking introduction of mail into the interior of the mail box to a lowered position allowing placement of mail, the obstruction portion coupled to the flap whereby when the flap is in the upright position, the obstruction portion disables the locking mechanism.

20. A mailbox comprising:
a housing comprising an enclosure portion and a door hinged thereto;
an incoming mail received indicator mechanism pivotally attached to the housing in the interior of the housing, the incoming mail received indicator mechanism comprising a flap moveable from an upright position blocking introduction of mail into the interior of the mail box to a retracted position allowing placement of mail in the interior, and an external flag pivotally connected to the housing and connecting to the flap, the flag moveable between a more visible postion and a lesser visible position whereby when the flap is in the upright position the flag is in the less visible position and when the flap is in the retracted position the flag is in the more visible position indicating the presence of incoming mail.
